(19) United States
(12) Patent Application Publication
(10) Pub. No.: US 2007/0041056 A1
(43) Pub. Date: Feb. 22, 2007

(54) Object operation apparatus and object operation method

(75) Inventors: Masanori Wakai, Kawasaki-shi (JP); Osamu Sakata, Yokohama-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha

(21) Appl. No.: 11/503,066

(22) Filed: Aug. 14, 2006

(30) Foreign Application Priority Data
Aug. 22, 2005 (JP) 2005-240201 (PAT.

(51) Int. Cl. H04N 1/40

(52) U.S. Cl. 358/448

(57) ABSTRACT

Objects processed in a plurality of information processing apparatuses connected over a network to an object operation apparatus are caused to be displayed on screens of a display device of the object operation apparatus in correspondence with the information processing apparatuses. Then, operations on the displayed objects on the screens corresponding to the information processing apparatuses are made controllable.

### BACKGROUND OF THE INVENTION

1. Field of the Invention

The present invention relates to an object operation apparatus and object operation method capable of operating objects processed in a plurality of information processing apparatuses connected over a network.

2. Description of the Related Art

A multidisplay system is known as a system that transmits objects to a plurality of information processing apparatuses and manages them. The multidisplay system described here refers to a system in which images delivered from an image delivery device located in a center are received and displayed by multiple display devices. In implementing such a system, various types of techniques for improving the cost or usability in the system have been proposed (See prior art references 1, 2 for example).

Prior art reference 1 discloses that a low-cost, reliable and serviceable system can be constructed by allowing a plurality of monitors to individually receive an image signal and to display the image signal according to a received display program without using a personal computer, etc. in the monitor units.

Prior art reference 2 discloses a display system having a plurality of display devices including multidisplay devices, and describes that the screens of other devices are displayed within a control device and a drop operation from an image list is made available on them. It also mentions that the differences in display capability are absorbed, and describes the usability on the control device side.

Note that prior art references 1, 2 described above are as follows:

Prior Art Reference 1: Japanese Patent Laid-Open No. 10-187109

Prior Art Reference 2: Japanese Patent Laid-Open No. 2001-166757

However, in the above described examples of the prior art, operations, such as for operating an object within an image being displayed on a monitor and causing the object to be displayed on another display screen, are not allowable. Also, the objects displayed on the plurality of monitors by the above described operation cannot be centrally managed. Further, the objects once displayed on the monitors cannot be disabled from being illegally used.

### SUMMARY OF THE INVENTION

It is an object of the present invention to cause objects processed in a plurality of information processing apparatuses to be displayed on a display device in correspondence with the information processing apparatuses and to make operations on the displayed objects controllable.

It is another object of the present invention to cause objects processed in a plurality of information processing apparatuses to be displayed on a display device in correspondence with the information processing apparatuses and to make operations, such as a drag & drop operation, on the displayed objects available.

According to one aspect of the present invention, an object operation apparatus capable of operating objects processed in a plurality of information processing apparatuses connected over a network comprising: display control means for displaying the objects processed in the plurality of information processing apparatuses on a display device in correspondence with the information processing apparatuses, and operation control means for making operations on the objects corresponding to the information processing apparatuses displayed by the display control means controllable, is provided in order to accomplish the above described objects.

According to another aspect of the present invention, an object operation apparatus capable of operating objects processed in a plurality of information processing apparatuses connected over a network comprising: transmission/reception means for transmitting/receiving objects to/from the plurality of information processing apparatuses over the network, and operation control means for making operations on any object across the information processing apparatuses controllable, is provided.

According to still another aspect of the present invention, an information processing apparatus comprising: object reception means for receiving objects from an object operation apparatus capable of operating the objects, operation permission request means for requesting operation permission for the objects, operation permission reception means for receiving the operation permission for the objects requested by the operation permission request means, and operation means for operating the objects for which the operation permission is received by the operation permission reception means, is provided.

According to a further aspect of the present invention, an object operation method capable of operating objects processed in a plurality of information processing apparatuses connected over a network comprising: a display control step of displaying the objects processed in the plurality of information processing apparatuses in correspondence with the information processing apparatuses on a display device, and an operation control step of making operations on the objects corresponding to the information processing apparatuses displayed in the display control step controllable, is provided.

According to a still further aspect of the present invention, an object operation method capable of operating objects processed in a plurality of information processing apparatuses connected over a network comprising: a transmission/reception step of transmitting/receiving the objects from/to the plurality of information processing apparatuses over the network, and an operation control step of making operations on any object across the information processing apparatuses controllable, is provided.

Further features of the present invention will be become apparent from the following description of exemplary embodiments with reference to the attached drawings.

### BRIEF DESCRIPTION OF THE DRAWINGS

FIG. 1 is a block diagram illustrating the hardware structure of an information processing apparatus in an embodiment;

FIG. 2 illustrates an example system image in a first embodiment;

FIG. 3 is a system block diagram illustrating a structure in which the system image shown in FIG. 2 is achieved;

FIG. 4 is a functional block diagram illustrating the functions of information processing apparatuses (an operation apparatus and apparatuses) in the first embodiment;

FIG. 5 illustrates an example object operation screen of an operation apparatus 201 in the first embodiment;

FIG. 6 illustrates an operation result corresponding to the drag & drop operation shown in FIG. 5;

FIG. 7 is a flow chart illustrating object operation processing of the operation apparatus 201 in the first embodiment;

FIG. 8 illustrates example object management data 207 of the operation apparatus 201 in the first embodiment;

FIG. 9 is a flow chart illustrating object management data addition processing of the operation apparatus 201 in the first embodiment;

FIG. 10 illustrates an example object management screen of the operation apparatus 201 in the first embodiment;

FIG. 11 is a flow chart illustrating object management processing in the first embodiment;

FIG. 12 illustrates an example object management screen on which size matching is designated in a second embodiment;

FIG. 13 illustrates an example object operation screen 1301 displayed as a result of the operation shown in FIG. 12;

FIG. 14 illustrates example object management data updated as a result of the operation shown in FIG. 12;

FIG. 15 illustrates an example object management screen on which location matching is designated in the second embodiment;

FIG. 16 illustrates an example object operation screen 1601 displayed as a result of the operation shown in FIG. 15;

FIG. 17 is example object management data updated as a result of the operation shown in FIG. 15;

FIG. 18 illustrates an example object management screen on which non-display is designated in the second embodiment;

FIG. 19 illustrates an example object operation screen 1901 displayed as a result of the operation in FIG. 18;

FIG. 20 illustrates example object management data updated as a result of the operation shown in FIG. 18;

FIG. 21 illustrates an example object management screen after deletion designation has been made in the second embodiment;

FIG. 22 illustrates an example object operation screen 2201 displayed as a result of the operation shown in FIG. 21;

FIG. 23 illustrates example object management data updated as a result of the operation shown in FIG. 21;

FIG. 24 illustrates an example system image in a third embodiment;

FIG. 25 is a system block diagram illustrating a structure in which the system image shown in FIG. 24 is achieved;

FIG. 26 illustrates an example system image in a fourth embodiment;

FIG. 27 is a flow chart illustrating object operation permission request response processing of the operation apparatus 201 in the fourth embodiment;

FIG. 28 is a flow chart illustrating object operation permission request determination processing of the operation apparatus 201 in the fourth embodiment;

FIG. 29 is a flow chart illustrating object operation processing of an information processing apparatus 2601 in the fourth embodiment;

FIG. 30 illustrates example object management data in which non-display is designated;

FIG. 31 illustrates an example system image when display is disabled in the fourth embodiment;

FIG. 32 illustrates an example system image when the apparatus 2601 is disconnected in the fourth embodiment;

FIG. 33 illustrates an example object operation screen on which objects within other apparatuses are operated;

FIG. 34 is example layout management data for each apparatus in a fifth embodiment;

FIG. 35 is a flow chart illustrating object operation processing in the fifth embodiment;

FIG. 36 is a flow chart illustrating other apparatus object selection processing in the fifth embodiment;

FIG. 37 illustrates an example operation screen on which display forms in other apparatuses can be designated in a sixth embodiment;

FIG. 38 is a flow chart illustrating display form change processing in the sixth embodiment;

FIG. 39 is a flow chart illustrating display processing of an information processing apparatus in the sixth embodiment;

FIG. 40 illustrates an example index display screen of the information processing apparatus in the sixth embodiment; and

FIG. 41 illustrates an example overlapping display screen of the information processing apparatus in the sixth embodiment.

### DESCRIPTION OF THE EMBODIMENTS

Best modes for carrying out the invention will now be described in detail with reference to the drawings.

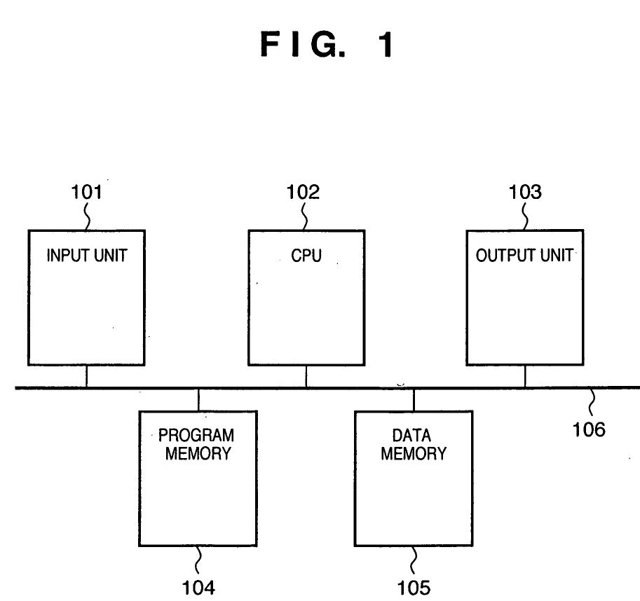

FIG. 1 is a block diagram illustrating the hardware structure of an information processing apparatus in an embodiment. In FIG. 1, reference numeral 101 is an input unit for inputting information (data), to which a photographing device, etc. is connected as described below. Reference numeral 102 is a CPU that performs arithmetic operations and logical decisions for various types of processing and controls elements connected to a bus described below. Reference numeral 103 is an output unit for outputting information (data), to which image forming devices, including, for example, a display such as LCD or CRT and a printer as described below, are connected.

Reference numeral 104 is a program memory that contains processing procedures shown in flow charts as described below and stores a program for control by the CPU 102. The program memory 104 may be a ROM, or a RAM to which a program is loaded from an external storage device, etc. Reference numeral 105 is a data memory that stores data generated in various types of processing. The data memory 105 may be, for example, a RAM, and the data is then loaded prior to processing, or is referred to as need arises, from a non-volatile external storage medium.

Reference numeral 106 is a bus for transferring address signals that indicate elements to be controlled by the CPU 102, control signals that control the elements, and data communicated with each other among the elements.

### First Embodiment

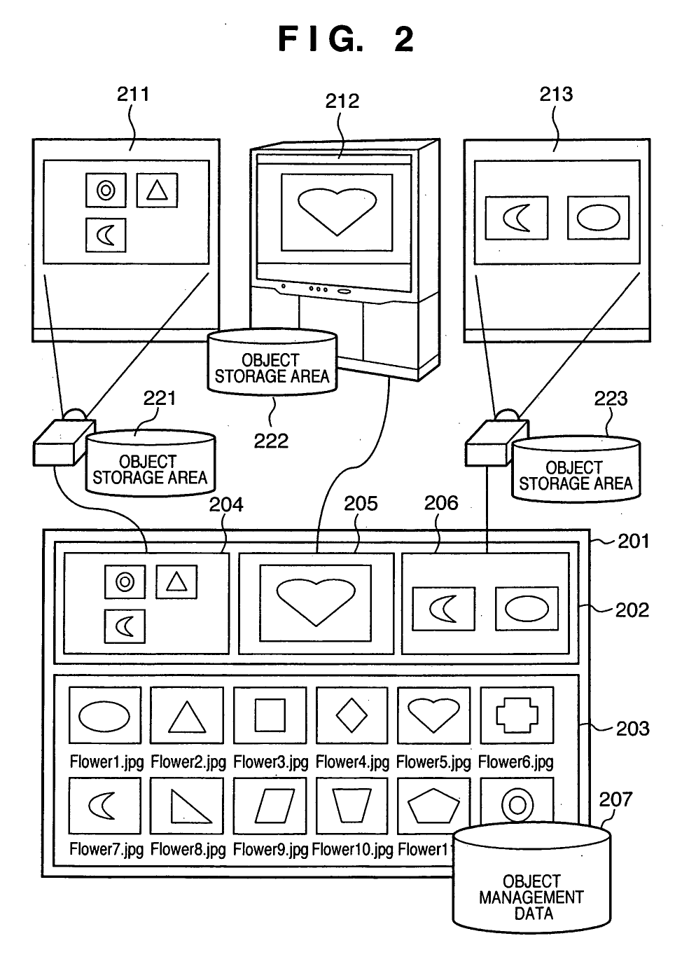

A description will now be given of an operation for listing objects distributed among a plurality of information processing apparatuses and for collectively specifying behaviors on the information processing apparatuses with reference to FIGS. 2 to 11.

FIG. 2 illustrates an example system image in the first embodiment. The system shown in FIG. 2 is a system that consists of a plurality of information processing apparatuses residing on a network. More specifically, FIG. 2 shows that front projection apparatuses 211, 213 and a rear projection apparatus 212 are operated from an object operation apparatus 201 over the network. Also, the front projection apparatus 211, the rear projection apparatus 212 and the front projection apparatus 213 (hereafter referred to as the apparatuses) have an object storage area 221, 222, 223 for storing respective display objects. Further, the object operation apparatus (hereafter referred to as the operation apparatus) 201 has object management data 207 for managing the objects of the apparatuses.

On the other hand, on the screen of the operation apparatus 201, an other apparatus display area 202 corresponding to the apparatuses and an object display area 203 displaying objects to be operated are provided. Further, within the other apparatus display area 202, images 204, 205, 206 corresponding to the apparatuses are displayed.

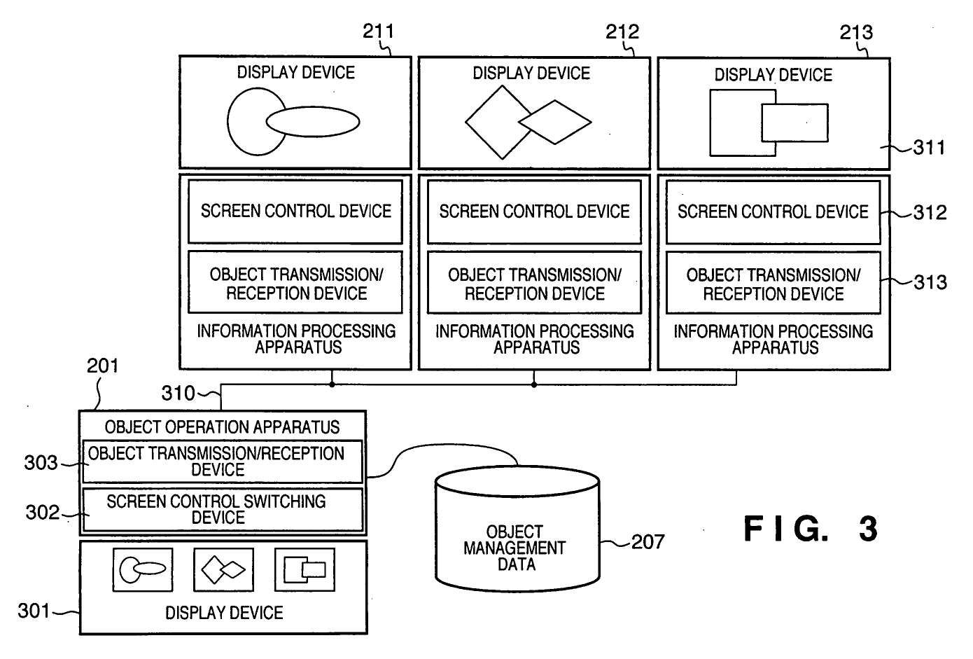

FIG. 3 is a system block diagram illustrating a structure in which the system image shown in FIG. 2 is achieved. As shown in FIG. 3, the apparatuses have their respective display devices 311 and are controlled by the operation apparatus 201 connected over the network 310. More specifically, the operation apparatus 201 has a display device 301 which displays the same images as those displayed on the display devices 311 of the apparatuses, and controls them using the object management data 207, which is the management information of the objects. Also, the operation apparatus 201 and the apparatuses are provided with their respective object transmission/reception devices 303, 313 for transmitting/receiving the objects between the operation apparatus 201 and the apparatuses.

Note that the display forms in the display devices 311 of the apparatuses are switched by a screen control switching device 302 of the operation apparatus 201 and displayed by screen control devices 312 of the apparatuses.

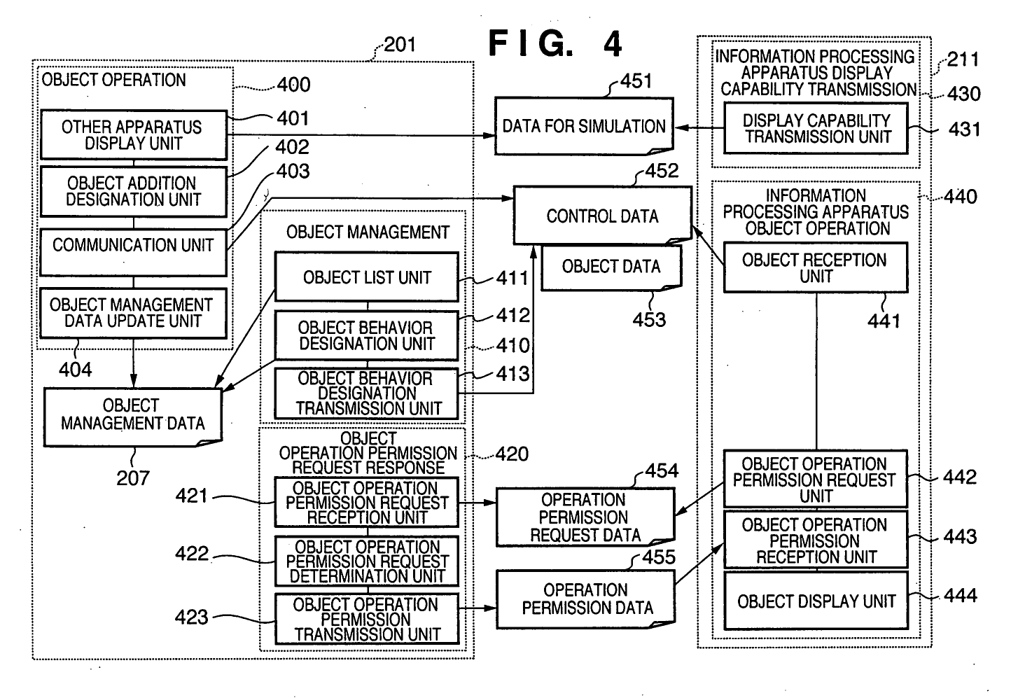

FIG. 4 is a functional block diagram illustrating the functions of the information processing apparatuses (the operation apparatus and the apparatuses) in the first embodiment. As shown in FIG. 4, the operation apparatus 201 has functions of object operation 400, object management 410, and object operation permission request response 420. On the other hand, the apparatuses have functions of information processing apparatus display capability transmission 430 and information processing apparatus object operation 440. While the front projection apparatus 211 of the apparatuses is shown as an example in FIG. 4, the other apparatuses also have the same functions.

The object operation 400 provides a function of centrally operating objects displayed on the apparatuses. The object management 410 provides a function of centrally managing the objects. The object operation permission request response 420 provides a function of executing processing in response to an object operation permission request from the apparatuses.

The information processing apparatus display capability transmission 430 provides a function of transmitting the display capability of the apparatus itself to the operation apparatus 201. The information processing apparatus object operation 440 provides a function of operating objects within the apparatus itself.

The object operation 400 described above is composed of another apparatus display unit 401, an object addition designation unit 402, a communication unit 403, and an object management data update unit 404. The other apparatus display unit 401 displays display images on the display devices 311 of the other apparatuses with reference to data for simulation 451 transmitted from the other apparatuses. The object addition designation unit 402 designates displaying of any objects to the other apparatuses. The communication unit 403 transmits control data 452 and object data 453 corresponding to the designation to the other apparatuses. The object management data update unit 404 adds and updates the object management data 207 corresponding to the designation.

Note that, while the other apparatus display unit 401 generates the display screens with reference to the data for simulation 451, it may also receive and display the screen images of the apparatuses in real time.

The object management 410 is composed of an object list unit 411, an object behavior designation unit 412 and an object behavior designation transmission unit 413. The object list unit 411 lists the object management data. The object behavior designation unit 412 responds by designating the behavior of any object. The object behavior designation transmission unit 413 transmits control data and object data corresponding to the designation to the other apparatuses.

The object operation permission request response 420 is composed of an object operation permission request reception unit 421, an object operation permission request determination unit 422 and an object operation permission transmission unit 423. The object operation permission request reception unit 421 receives operation permission request data 454 from the other apparatuses. The object operation permission request determination unit 422 determines the request. The object operation permission transmission unit 423 transmits operation permission data 455 corresponding to the determination result to the other apparatuses.

On the other hand, the information processing apparatus display capability transmission 430 is composed of a display capability transmission unit 431 that transmits the display capability of the apparatus itself as data for simulation to the operation apparatus 201. The information processing apparatuses object operation 440 is composed of an object reception unit 441, an object operation permission request unit 442, an object operation permission reception unit 443 and an object display unit 444. The object reception unit 441 receives the control data and the object data from the operation apparatus 201. The object operation permission request unit 442 transmits operation permission for an object as operation permission request data to the operation apparatus 201. The object operation permission reception unit 443 receives the determination result from the operation apparatus 201 in response to the request as operation permission data. The object display unit 444 displays the object.

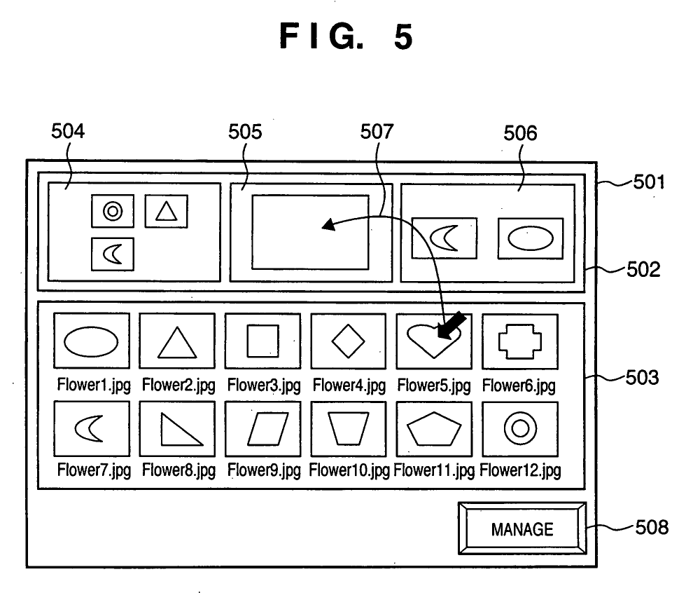

FIG. 5 illustrates an example object operation screen of the operation apparatus 201 in the first embodiment. The object operation screen 501 shown in FIG. 5 is provided with another apparatus display area 502 and an object display area 503 that displays a group of objects to be operated. Within the other apparatus display area 502, images 504, 505, 506 corresponding to the other apparatuses are displayed. Further, a manage button 508 for managing the objects displayed on the other apparatuses is also placed.

On this operation screen 501, a user can cause any object within the object display area 503 to be displayed on the images corresponding to the other apparatuses by a drag & drop operation 507.

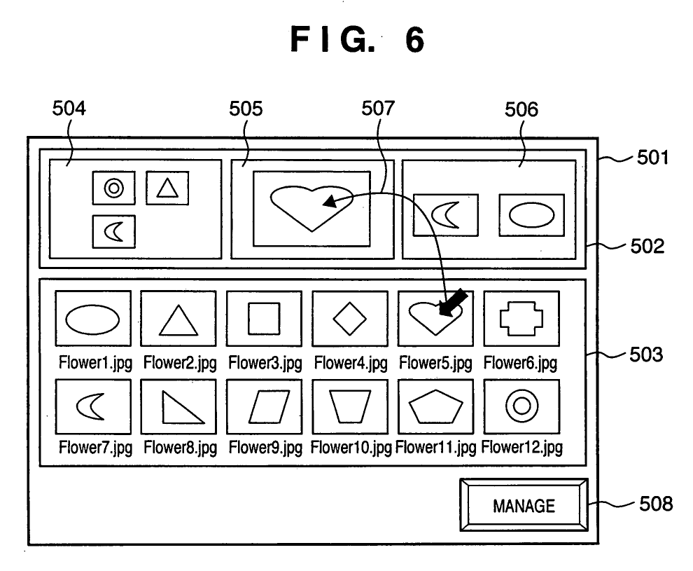

FIG. 6 illustrates the operation result corresponding to the drag & drop operation shown in FIG. 5. As shown in FIG. 6, the object at the drag location is displayed on the apparatus image 505 at the dropped location.

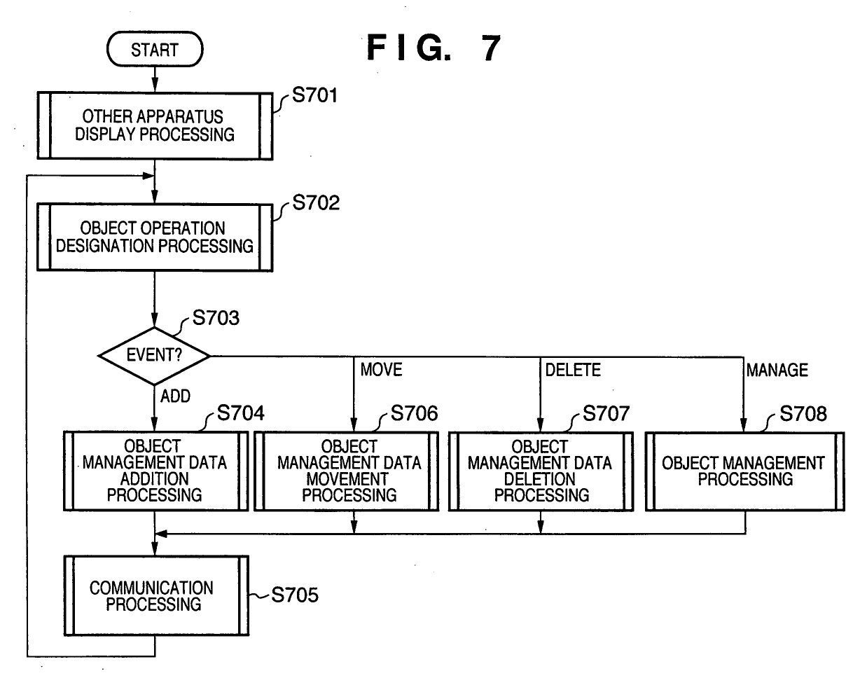

FIG. 7 is a flow chart illustrating object operation processing of the operation apparatus 201 in the first embodiment. First, in step S701, screen images of the other apparatuses are generated and displayed with reference to the data for simulation 451 obtained from the other apparatuses by the other apparatus display unit 401, and the subsequent processing from step S702 are repeated. In step S702, object operation designation by the user is received using object operation designation processing, and the process branches in step S703. In step S703, if the operation is an add operation of objects to any of the apparatuses, the process proceeds to step S704 and the object management data corresponding to the add operation is added using object management data addition processing. Then, in step S705, the corresponding control data and the object data is transmitted to the apparatus using communication processing, and the process returns back to step S702 and repeats the above described processing.

Also, in step S703, if the operation is an object move operation from one apparatus to another, the process proceeds to step S706, and the object management data corresponding to the move operation is updated using object management data movement processing. Then, in step S705, the corresponding control data and the object data is transmitted to the other apparatus using the communication processing, and the process returns to step S702 and repeats the above described processing. Also, in step S703, if the operation is an object delete operation from any of the apparatuses, the process proceeds to step S707, and the object management data corresponding to the delete operation is deleted using the object management data deletion processing. Then, in step S705, the corresponding control data is transmitted using the communication processing, and the process returns to step S702 and repeats the above described processing.

Also, in step S703, if the operation is a manage operation of all the objects being displayed on the other apparatuses, the process proceeds to step S708 to receive and execute the object manage operation using object management processing. Then, in step S705, the corresponding control data and the object data is transmitted to the other apparatuses by communication processing, and the process returns to step S702 and repeats the above described processing.

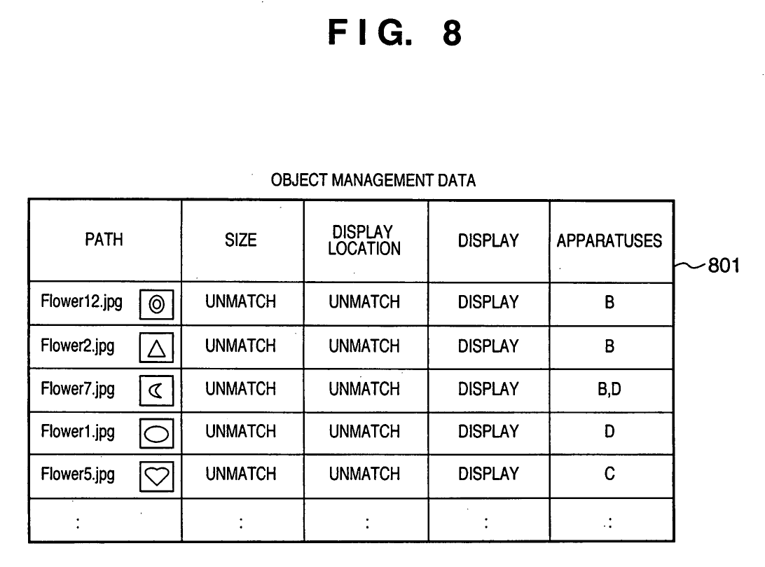

FIG. 8 illustrates example object management data 207 of the operation apparatus 201 in the first embodiment. The object management data 207 records paths for identifying objects, specification as to whether or not to match display sizes with each other among a plurality of other apparatuses, specification as to whether or not to match display locations with each other, specification as to whether or not to display, and identification information of the other apparatuses in which the objects are being displayed. For example, as object management data 801, Path=“Flower12.jpg” is set to and managed as Size=Unmatch, Display Location=Unmatch, Display Designated, and Displayed on Apparatus B.

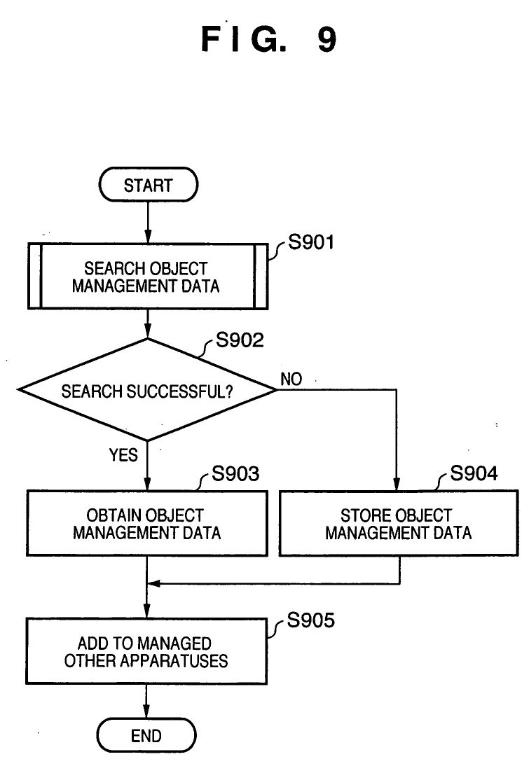

FIG. 9 is a flow chart illustrating object management data addition processing of the operation apparatus 201 in the first embodiment. First, in step S901, a search is conducted to see whether or not object management data corresponding to a target object already exists using object management data search processing. Then, a determination is made in step S902, and if the search is successful, the process proceeds to step S903 to obtain the existing object management data. If the search is not successful, the process proceeds to step S905 to add new object management data. Then, in step S904, the apparatus to which the object is added is added to the managed apparatuses of the object management data, and the process ends.

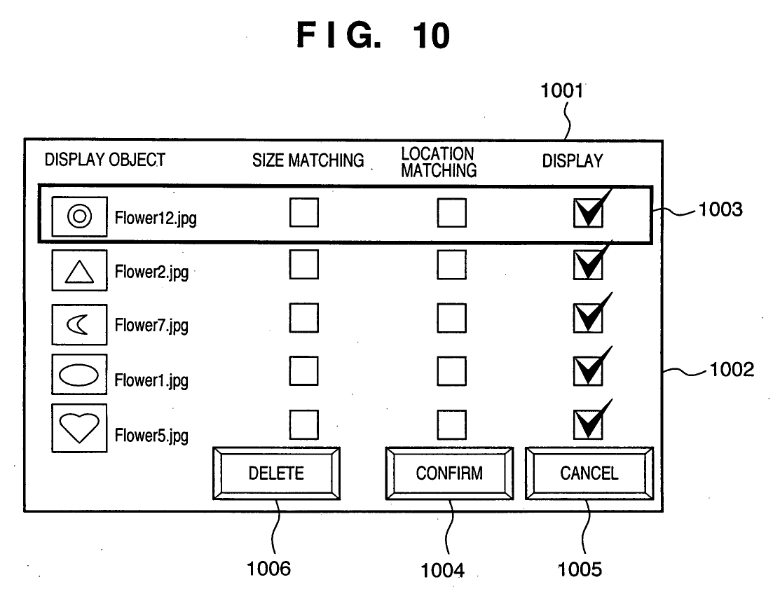

FIG. 10 illustrates an example object management screen of the operation apparatus 201 in the first embodiment. As shown in FIG. 10, in the object management data display area 1002 of the object management screen 1001, checkboxes are provided for specifying size matching, location matching, and display status, which can be designated by the user, for each display object. Also placed are a delete button 1006 for designating deletion of object management data 1003 being selected, a confirm button 1004 for confirming the specified content, and a cancel button 1005 for canceling the operations.

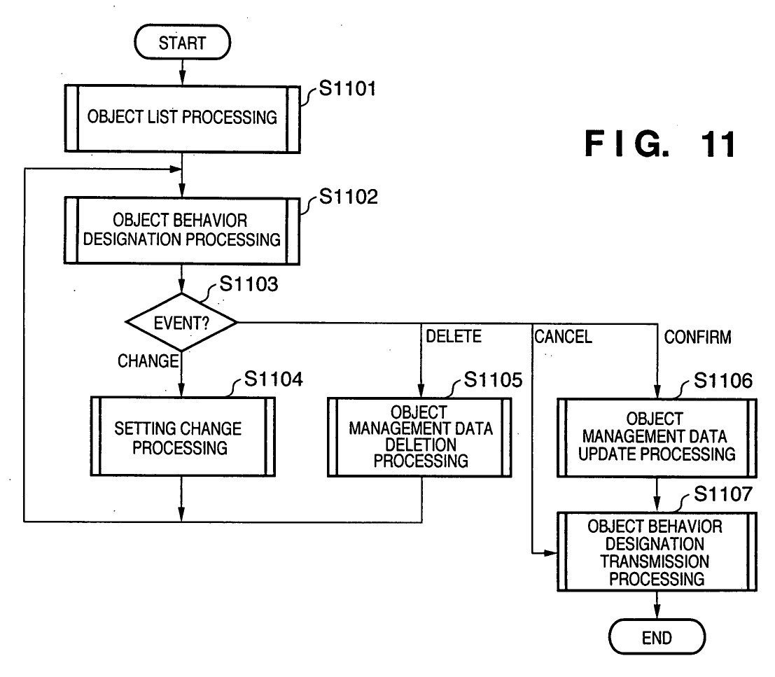

FIG. 11 is a flow chart illustrating object management processing in the first embodiment. First, in step S1101, the object management data 207 is listed by the object list unit 411, and the subsequent processing from step S1102 is repeated. In step S1102, the user designation made on the object management screen is accepted by the object behavior designation unit 412, and the process branches in step S1103. In step S1103, if the designation is determined to be a change operation in various settings, the process proceeds to step S1104 to make the change using setting change processing, and then returns to step S1102 and repeats the above described processing. In step S1103, if the designation is determined to be a delete operation of object management data being selected, the process proceeds to step S1105 to delete the object management data using object management data deletion processing, then returns to step S1102 and repeats the above described processing.

Also, in step S1103, if the designation is determined be a confirm operation of these settings, the process proceeds to step S1106 to update the object management data with the specified content using object management data update processing. Then, in step S1107, the corresponding control data and object management data is transmitted to the apparatuses by the object behavior designation transmission unit 413 and the process ends. Also, in step S1103, if the designation is determined to be a cancel operation, the process ends.

In this way, according to the first embodiment, objects distributed among a plurality of information processing apparatuses can be centrally managed. Also, a list of the objects distributed among the plurality of information processing apparatuses can be viewed and used to collectively specify the behaviors of the objects on the plurality of information processing apparatuses.

### Second Embodiment

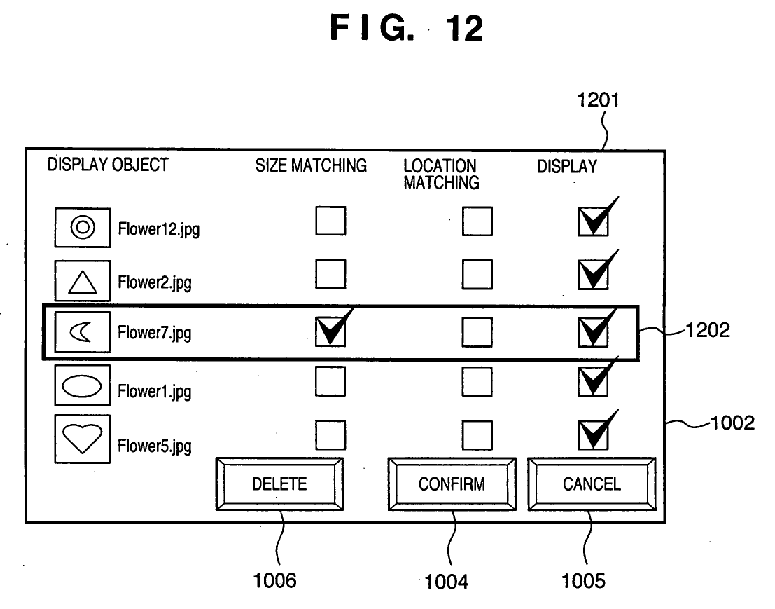

A second embodiment according to the present invention will now be described in detail with reference to FIGS. 12 to 23. In the second embodiment, specific operations for listing objects distributed among a plurality of information processing apparatuses, and centrally specifying the behaviors of them on the information processing apparatuses are described.

FIG. 12 illustrates an example object management screen on which size matching is designated in the second embodiment. FIG. 12 shows that the checkbox for the size matching of the object management data 1202 being selected is changed to be selected on the object management screen 1201.

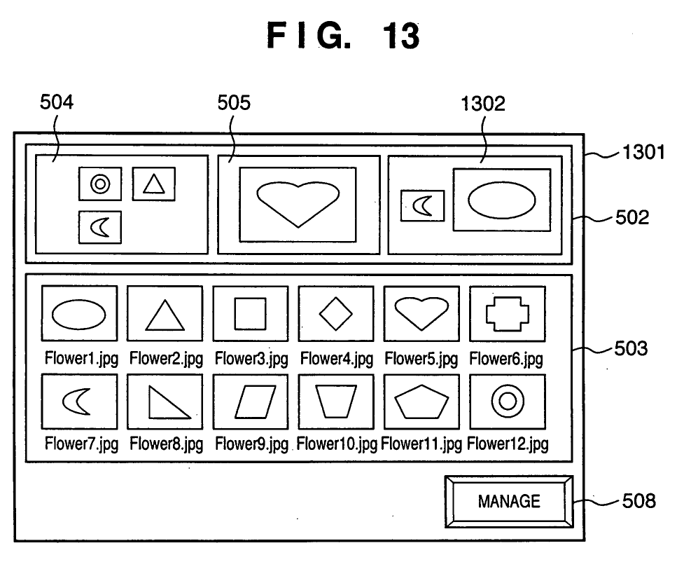

FIG. 13 illustrates an example object operation screen 1301 displayed as a result of the operation shown in FIG. 12. The object “Flower7.jpg” for which the size matching designation has been made in FIG. 12 is displayed on both of the images 504, 1302 corresponding to the apparatuses in the other apparatus display area 502. They are displayed in the same size in response to the designation of the size matching.

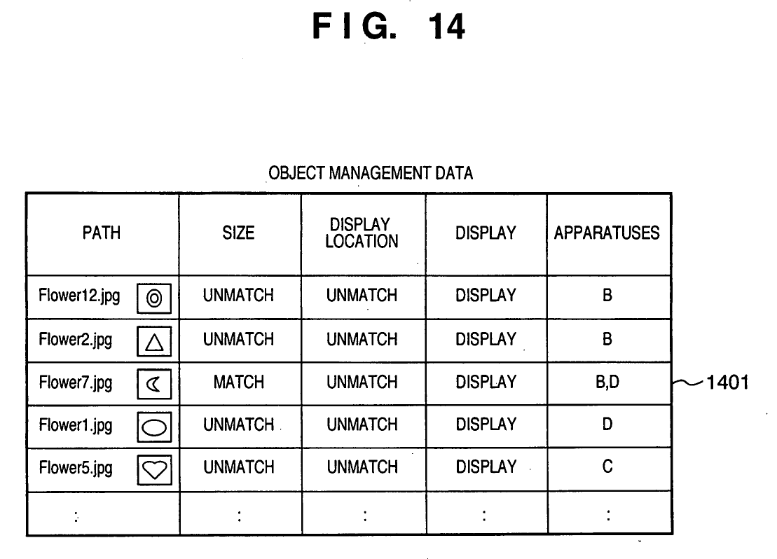

FIG. 14 illustrates example object management data updated as a result of the operation shown in FIG. 12. As shown in FIG. 14, the setting of the object management data 1401 has been changed to Size=Match.

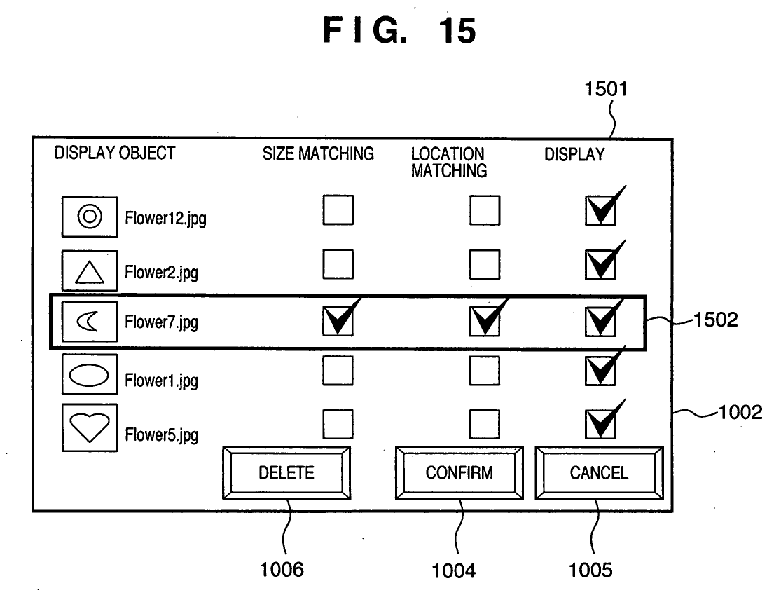

FIG. 15 illustrates an example object management screen on which location matching is designated in the second embodiment. FIG. 15 shows that the checkbox for the location matching of the object management data 1502 being selected has been changed to be selected on the object management screen 1501.

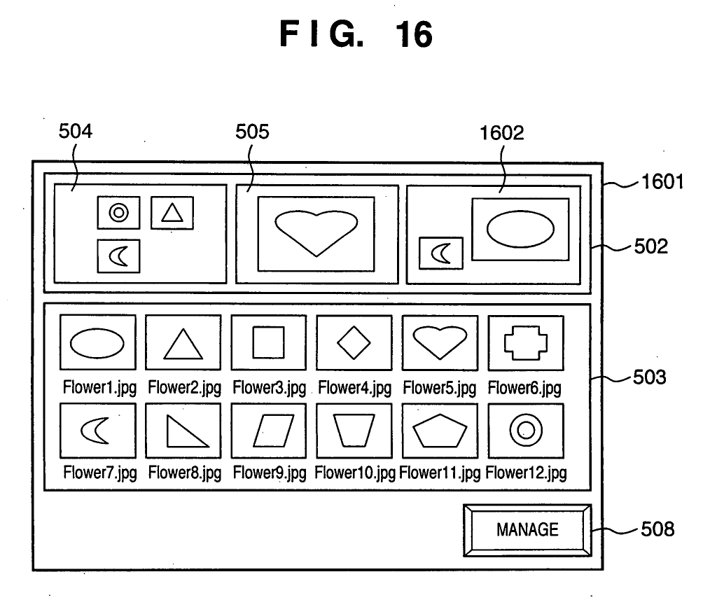

FIG. 16 illustrates an example object operation screen 1601 displayed as a result of the operation shown in FIG. 15. The object “Flower7.jpg” for which the location matching designation has been made in FIG. 15 is displayed on both of the images 504, 1602 corresponding to the apparatuses in the other apparatus display area 502. They are displayed at the same location (in the height direction) in response to the designation of the location matching.

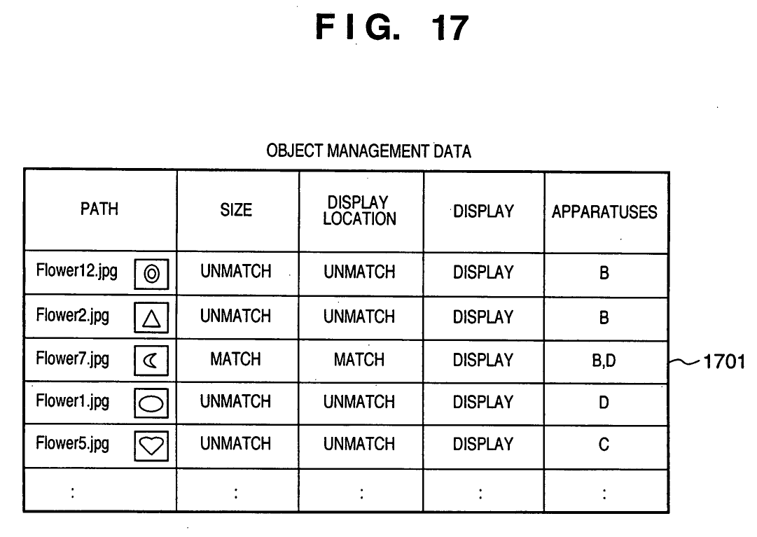

FIG. 17 is example object management data updated as a result of the operation shown in FIG. 15. As shown in FIG. 17, the setting of the object management data 1701 has been changed to Display Location=Match.

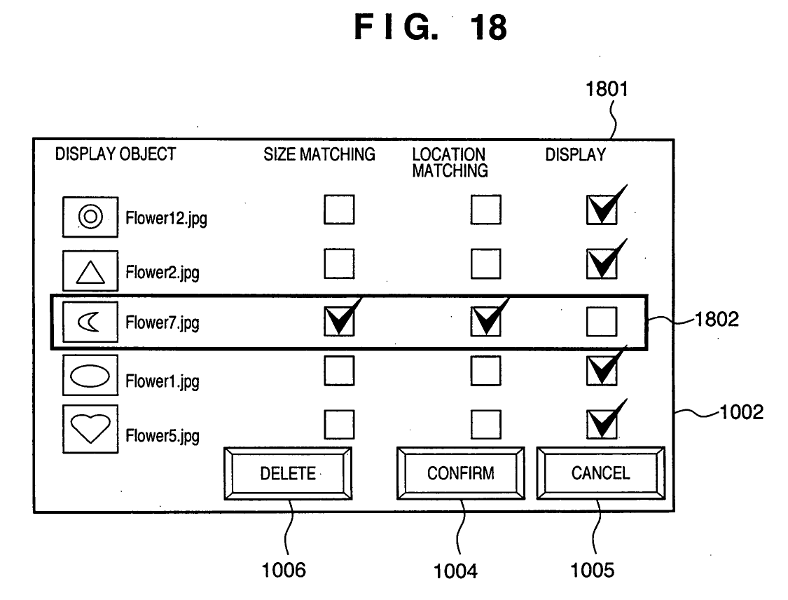

FIG. 18 illustrates an example object management screen on which non-display is designated in the second embodiment. FIG. 18 shows that the checkbox for the display designation of the object management data 1802 being selected has been changed to non-display on the object management screen 1801.

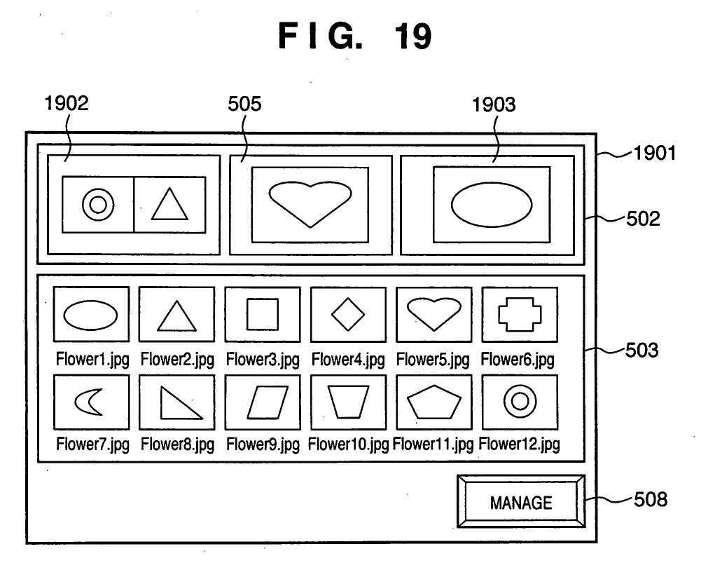

FIG. 19 illustrates an example object operation screen 1901 displayed as a result of the operation in FIG. 18. The object “Flower7.jpg” for which the non-display designation has been made in FIG. 18 is non-displayed on both of the images 1902, 1903 corresponding to the apparatuses in the other apparatus display area 502.

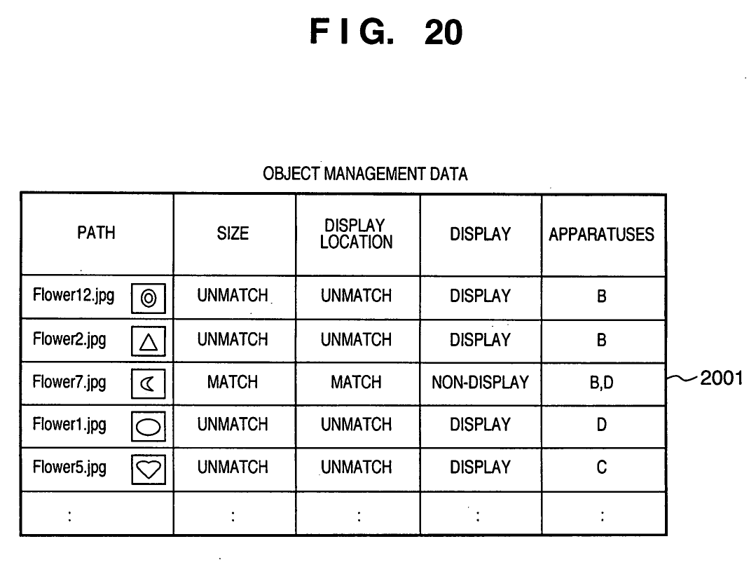

FIG. 20 illustrates example object management data updated as a result of the operation shown in FIG. 18. As shown in FIG. 20, the setting of the object management data 2001 has been changed to Display Designation=Non-Display.

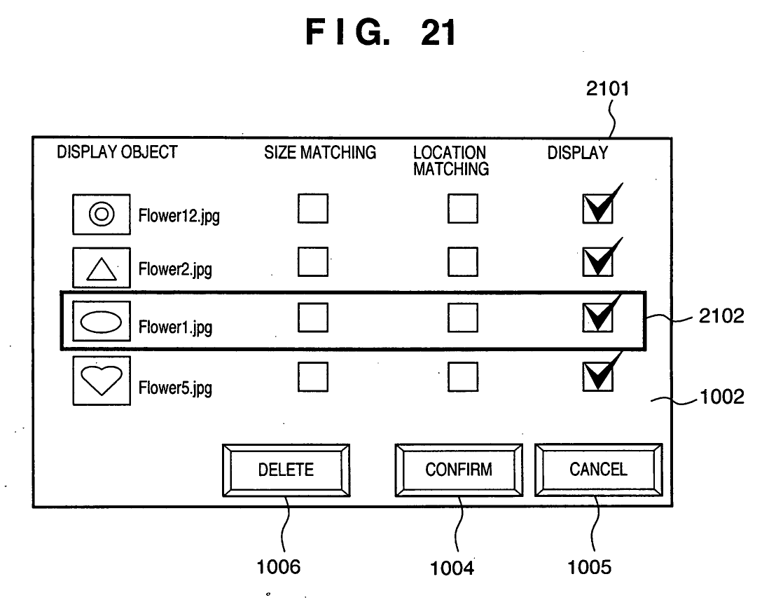

FIG. 21 illustrates an example object management screen after deletion designation has been made in the second embodiment. FIG. 21 shows that the object management data of the object “Flower7.jpg,” which had been selected in FIGS. 12, 15 and 18, has been deleted on the object management screen 2101. The object management data 2102 of the next object “Flower1.jpg” is selected.

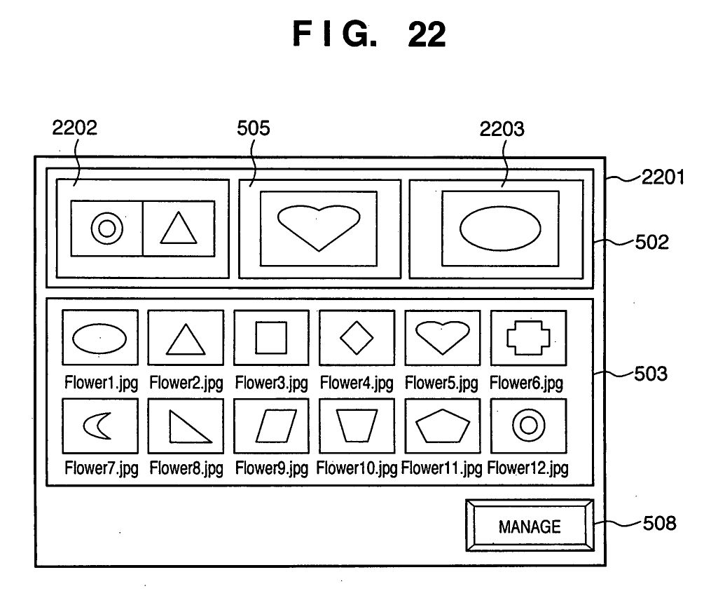

FIG. 22 illustrates an example object operation screen 2201 displayed as a result of the operation shown in FIG. 21. The object “Flower7.jpg” deleted in FIG. 21 has been deleted on both of the images 2202, 2203 corresponding to the apparatuses in the other apparatus display area 502.

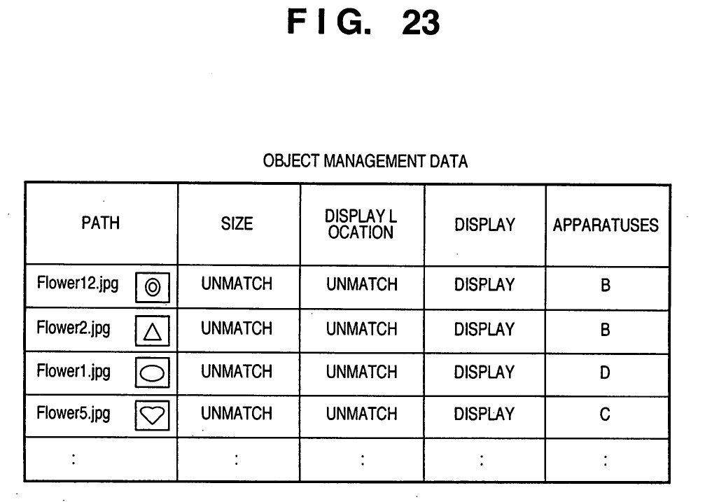

FIG. 23 illustrates example object management data updated as a result of the operation shown in FIG. 21. As shown in FIG. 23, the deleted object management data has been lost.

In this way, according to the second embodiment, the designation of size matching, display location matching, display, deletion, etc. of objects on a plurality of information processing apparatuses can be made, in addition to the advantages of the first embodiment.

### Third Embodiment

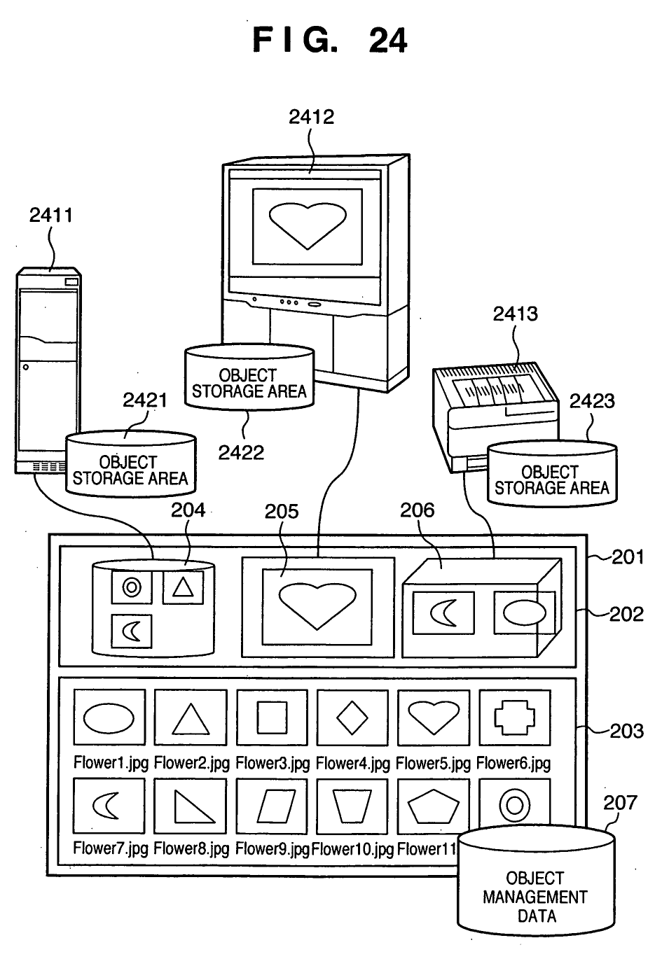

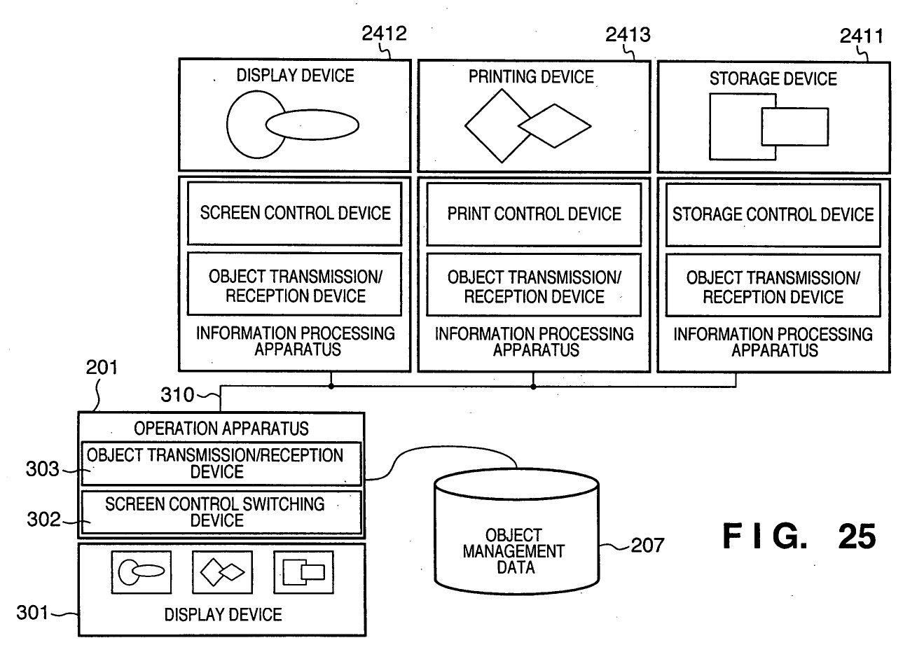

A third embodiment according to the present invention will now be described in detail using FIGS. 24 and 25. In the third embodiment, an example is described in which target apparatuses that can be operated as the other apparatuses are not limited to display devices, but apparatuses including recording devices and printing devices that can manage objects as with the display devices is used.

FIG. 24 illustrates an example system image in the third embodiment. The system shown in FIG. 24 is a system consisting of a plurality of information processing apparatuses residing on a network. More specifically, FIG. 24 shows that a storage device 2411, a rear projection apparatus 2412 and a printing device 2413 are operated from an operation apparatus 201 over the network. Also, the storage device 2411, the rear projection apparatus 2412 and the printing device 2413 (the apparatuses) are provided with an object storage area 2421, 2422, 2423 for storing respective objects. Note that the operation apparatus 201 is the same as that in FIG. 2 as described in the first embodiment.

FIG. 25 is a system block diagram illustrating a structure in which the system image shown in FIG. 24 is achieved. As shown in FIG. 25, the apparatuses are controlled by the operation apparatus 201 respectively connected via the network 310. The storage device 2411 has a storage control device and an object transmission/reception device, and the printing device 2413 has a print control device and an object transmission/reception device. Note that the other components are the same as those in FIG. 3 as described in the first embodiment.

In this way, according to the third embodiment, objects distributed among a plurality of information processing apparatuses, including storage devices and printing devices, can be centrally managed.

Also, a list of the objects distributed among the plurality of information processing apparatuses, including storage devices and printing devices, can be viewed and used to collectively specify the behaviors of the objects on the plurality of information processing apparatuses.

### Fourth Embodiment

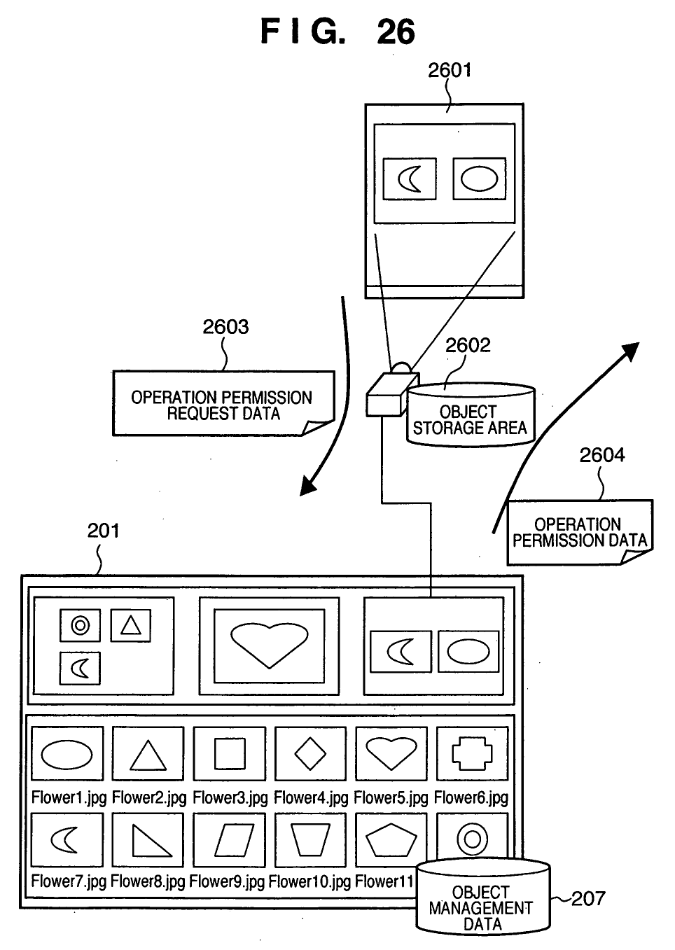

A fourth embodiment according to the present invention will now be described in detail using FIGS. 26 to 32. The fourth embodiment describes, by way of example, a case in which illegal utilization of distributed objects can be disabled in cooperation with the object operation apparatus.

FIG. 26 illustrates an example system image in the fourth embodiment. The system shown in FIG. 26 is a system that consists of a plurality of information processing apparatuses residing on a network. More specifically, it is a system in which an object 2602, which is operated by a front projection apparatus (hereafter referred to as an apparatus) 2601 via the network, is operated by operation permission of the operation apparatus 201 having object management data 207.

For example, when any object is displayed on the apparatus 2601, operation permission request data 2603 is transmitted from the apparatus 2601 to the operation apparatus 201, and operation permission data 2604 corresponding to the result determined by the operation apparatus 201 is received and a determination is made as to whether or not the object can be displayed.

Note that the example in FIG. 26 shows that the display operation of the object has been permitted.

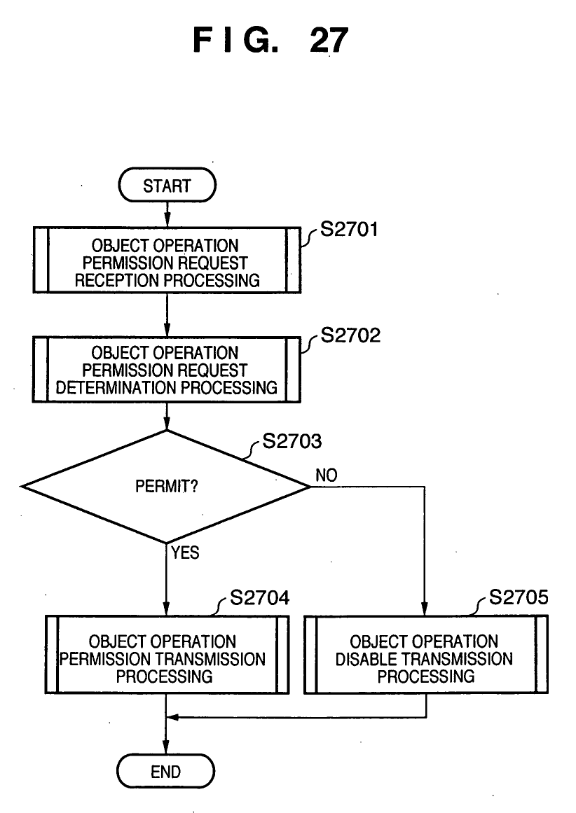

FIG. 27 is a flow chart illustrating object operation permission request response processing of the operation apparatus 201 in the fourth embodiment. First, in step S2701, the object operation permission request reception unit 421 receives object operation permission request data 2603 transmitted from the apparatus 2601. Then, in step S2702, the object operation permission request determination unit 422 determines as to whether or not the operation permission request is permitted, and in step S2703 the process branches based on the result. If a determination is made that the request is permitted, the process proceeds to step S2704, in which the object operation permission transmission unit 423 transmits operation permission data 2604 to the requesting apparatus 2601. If a determination is made that the request is not permitted, the process proceeds to step S2705 in which operation disable data is sent to the requesting apparatus using object operation disable transmission processing, and the process ends.

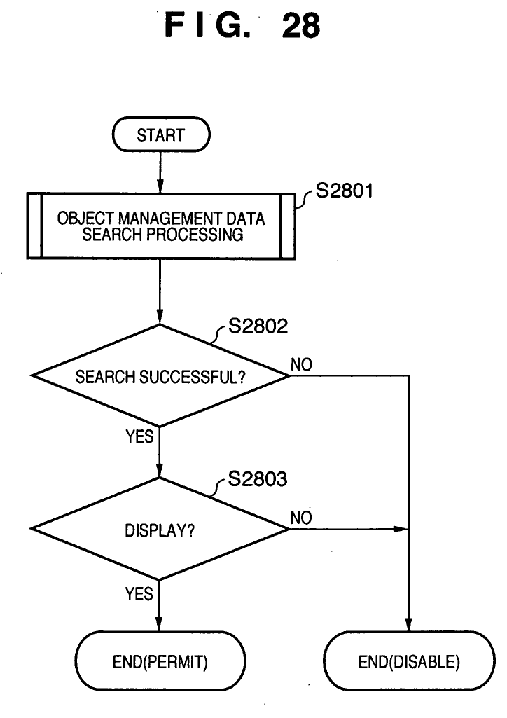

FIG. 28 is a flow chart illustrating the object operation permission request determination processing of the operation apparatus 201 in the fourth embodiment. First, in step S2801, object management data corresponding to the object requested from the apparatus is searched by using object management data detection processing. Then, in step S2802, the search result is determined. If the search is determined to be successful, the process proceeds to step S2803 to determine whether or not the display is permitted. If the display is permitted in the object management data 207, the process ends with a conclusion that the operation is permitted.

On the other hand, in step S2802, if the search is not determined to be successful, or in step S2803, if a determination is made that the display is not permitted, the process ends with a conclusion that the operation is disabled.

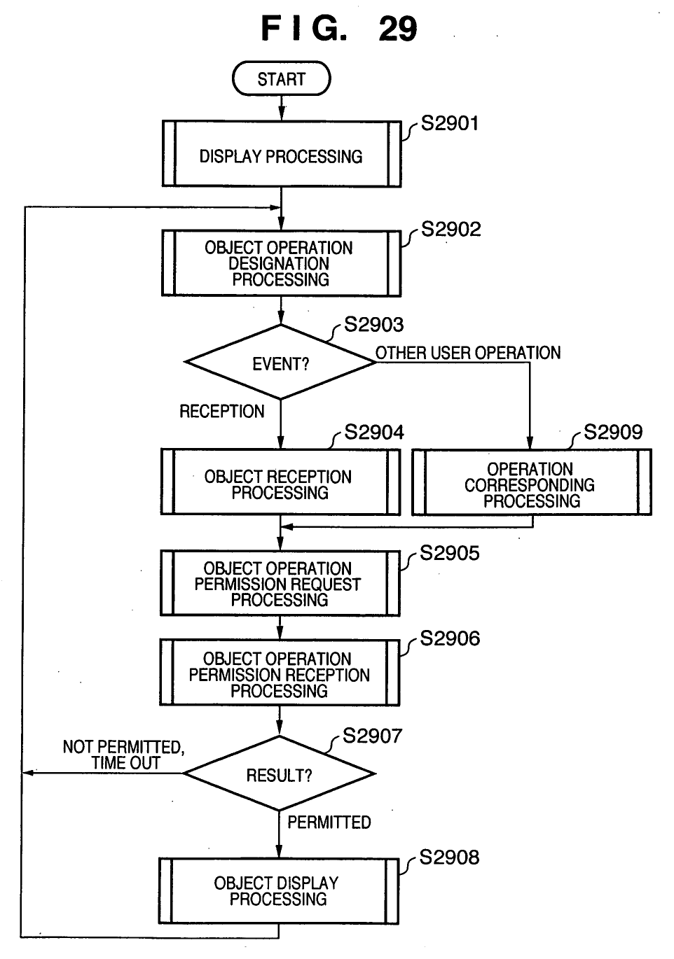

FIG. 29 is a flow chart illustrating object operation processing of the apparatus 2601 in the fourth embodiment. First, in step S2901, the initial operation environment is displayed on the display device using display processing, and the subsequent processing from step S2902 is repeated. In step S2902, an operation by the user is accepted using object operation designation processing, and the process branches at step S2903. If the event detected in step S2903 is a reception event, the process proceeds to step S2904, in which control data and object data transmitted from the apparatus is received by the object reception unit 441. If the event is any other user operation, the process proceeds to step S2909, in which processing corresponding to the operation is executed using operation response processing.

Then, in step S2905, an operation permission request for the target object of the operation is transmitted by the object operation permission request unit 442. Then, in step S2906, a result in response to the request is received by the object operation permission reception unit 443. Then, in step S2907, the result is determined. If it is determined that the operation is permitted, the process proceeds to step S2908, in which the target object is displayed using object display processing. Then, the process returns to step S2902 and repeats the above described processing.

On the other hand, in step S2907, if it is determined that the object operation is not permitted or is timed out, the process returns to step S2902 and repeats the above described processing.

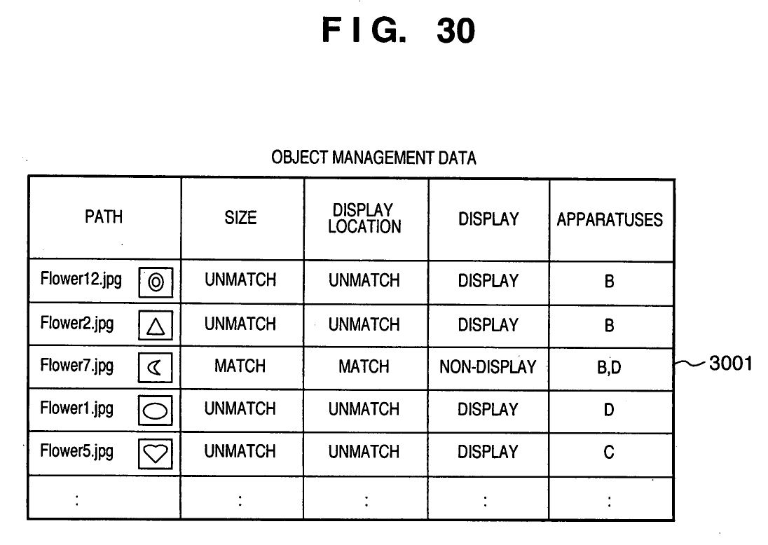

FIG. 30 illustrates example object management data in which non-display is designated. As shown in FIG. 30, the displaying of an object can be disabled by setting the object management data 3001 of the object to Display Designation=Non-Display.

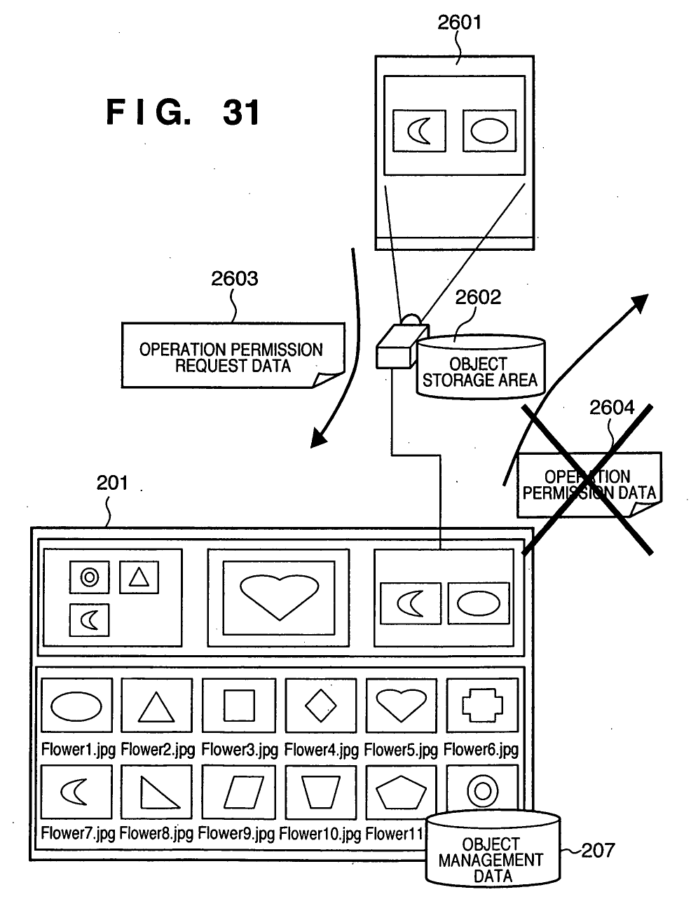

FIG. 31 illustrates an example system image in the fourth embodiment in which display is disabled. FIG. 31 shows control in the system involved in the object operation permission where the object management data is set to non-display as shown in FIG. 30. In FIG. 31, because the object management data 3001 corresponding to the operation target object is set to non-display, it is determined that the operation is disabled in step S2803. As a result, the operation permission data is not transmitted and thus the object is not displayed.

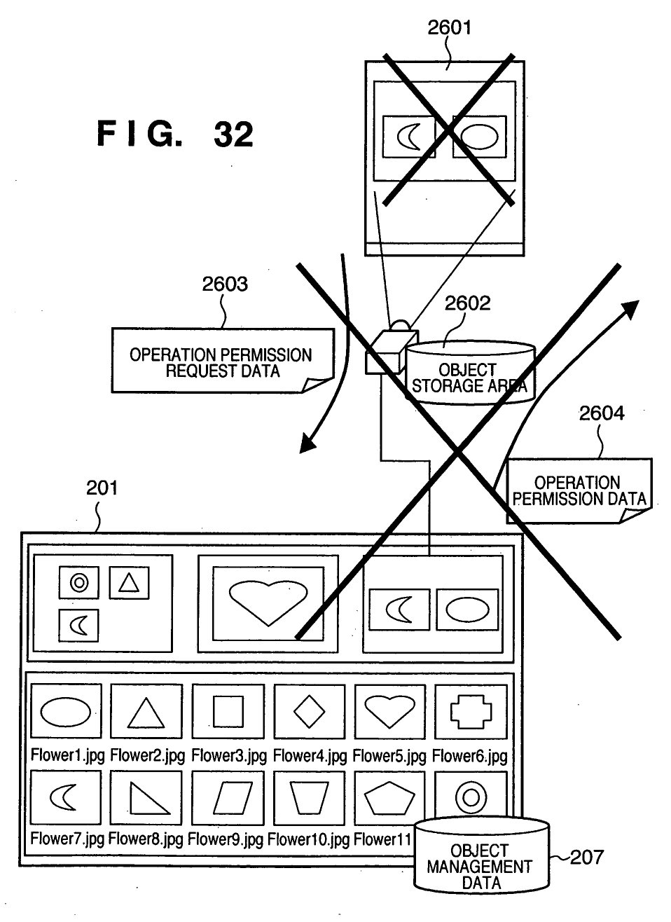

FIG. 32 illustrates an example system image when the apparatus 2601 is disconnected in the fourth embodiment. FIG. 32 shows a system image which includes control involved in the object operation permission where the operation apparatus 201 having the object management data 207 cannot be accessed.

In this case, because the operation apparatus 201 having the object management data 207 cannot be accessed, it is determined that the operation is timed out in step S2907 and displaying of all the objects fails.

In this way, according to the fourth embodiment, illegal utilization of distributed objects can be disabled and cooperation with information processing apparatuses can be achieved.

### Fifth Embodiment

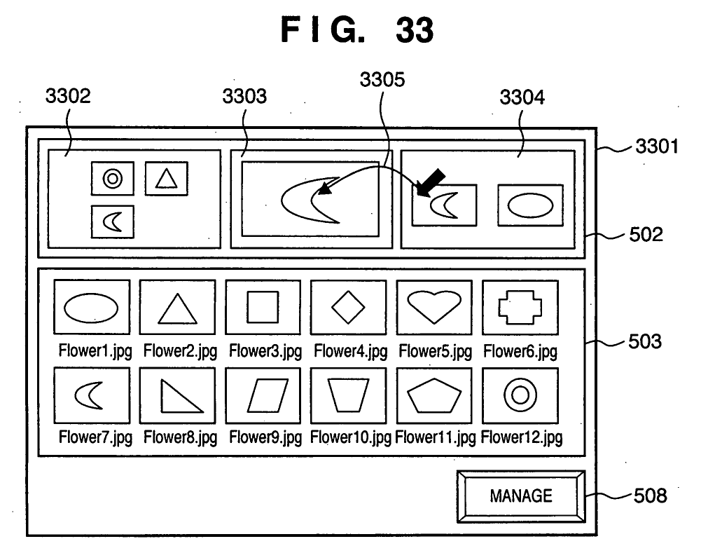

A fifth embodiment according to the present invention will now be described in detail using FIGS. 33 to 36. The fifth embodiment describes, by way of example, a case where an object within the other apparatuses is selected and operated.

FIG. 33 illustrates an example object operation screen on which an object within the other apparatuses is operated. By performing a drag & drop operation 3305 on the object operation screen 3301 shown in FIG. 33, any object in one apparatus display image 3304 is dragged onto another image 3303 corresponding to another apparatus.

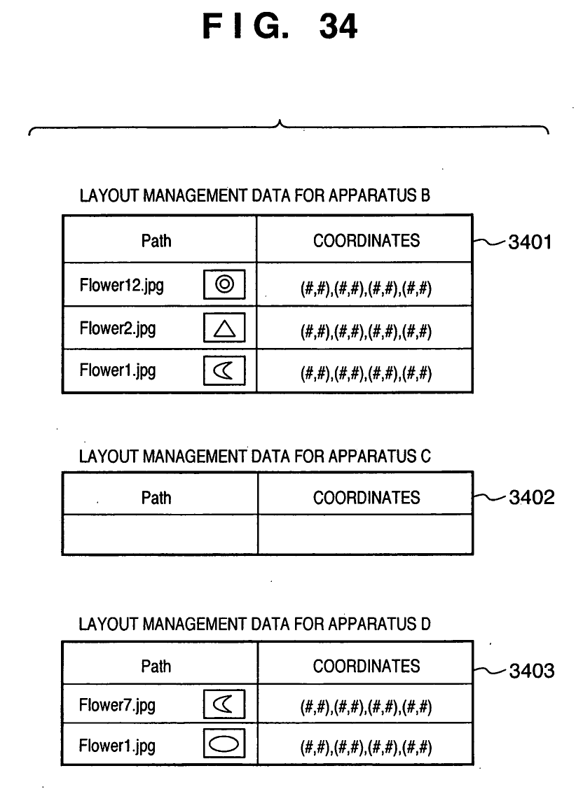

FIG. 34 is example layout management data for each apparatus in the fifth embodiment. As shown in FIG. 34, the layout management data for each apparatus 3401, 3402, 3403 stores paths for identifying objects together with display their coordinates on the display screen of the operation apparatus 201.

For example, the layout management data 3403 of Apparatus D stores Path=“Flower7.jpg” together with the display coordinates. As shown in FIG. 33, if an object of Apparatus D is moved to Apparatus C by a drag & drop operation 3305, its path and the display coordinates are stored in the layout management data 3402 of Apparatus C as with the layout management data 3403 of Apparatus D.

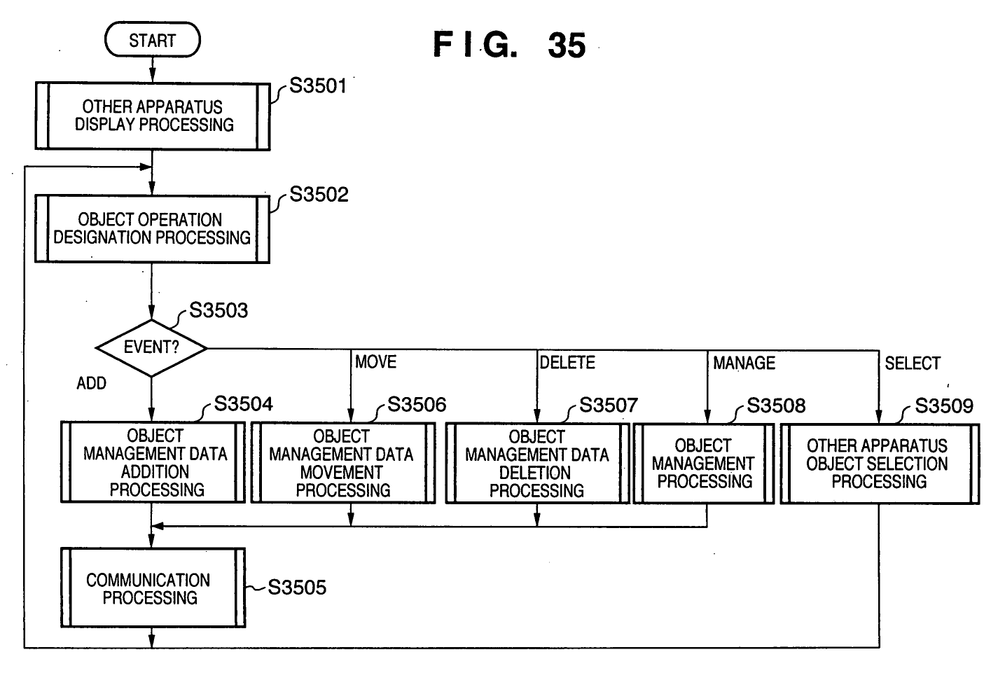

FIG. 35 is a flow chart illustrating object operation processing in the fifth embodiment. First, in step S3501, the screen images of the other apparatuses are generated and displayed with reference to the data for simulation obtained from the other apparatuses by the other apparatus display unit 401, and the subsequent processing is repeated. In step S3502, an object operation designation by the user is accepted using object operation designation processing, and the process branches based on the operation designation in step S3503. In step S3503, if it is determined that the operation designation is an object add operation to any of the apparatuses, the process proceeds to step S3504, in which the object management data corresponding to the operation is added using object management data addition processing. Then, in step S3505, the corresponding control data and object data is transmitted to the apparatus using communication processing, and the process returns to step S3502 and repeats the above described processing.

Also, in step S3503, if it is determined that the operation designation is an object move operation from one apparatus to another, the process proceeds to step S3506, in which the object management data corresponding to the operation is updated using object management data movement processing. Then, in step S3505, the corresponding control data and object data is transmitted to the other apparatus using communication processing, and the process returns to step S3502 and repeats the above described processing.

Also, in step S3503, if it is determined that the operation designation is an object delete operation from any of the apparatuses, the process proceeds to step S3507, where the object management data corresponding to the operation is deleted using object management data deletion processing. Then, in step S3505, the corresponding control data is transmitted to the apparatus using communication processing, and the process returns to step S3502 and repeats the above described processing.

Also, in step S3503, if it is determined that the operation designation is a manage operation of all the objects displayed on the other apparatuses, the process proceeds to step S3508, in which the object manage operation is accepted and executed using object management processing. Then, in step S3505, the corresponding control data and object data is transmitted to the other apparatuses using communication processing, and the process returns to step S3502 and repeats the above described processing.

Also, in step S3503, if it is determined that the operation designation is a select operation of an object displayed on any of the apparatuses, the process proceeds to step S3509, in which the object is selected using other apparatus object selection processing. Then, the process returns to step S3502 and repeats the above described processing.

By the above described processing, the object within one of the apparatuses selected by a drag operation is moved to another apparatus by a drop operation, the object management data is updated, and the transmission processing of the control data and object data to the other apparatus is executed.

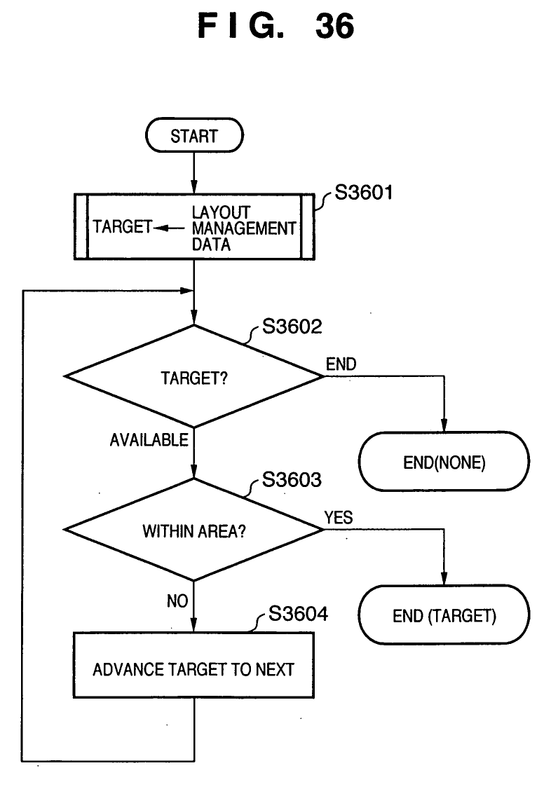

FIG. 36 is a flow chart illustrating the other apparatus object selection processing in the fifth embodiment. First, in step S3601, the top of the layout management data is initialized as a target and the subsequent processing from step S3602 is repeated. In step S3602, if it is determined that the target is available, the process proceeds to step S3603, if not, it is determined that there is no object at the specified location and the process ends.

In step S3603, a determination is made as to whether or not the specified location is within the coordinate area of the target layout management data, and if it is not within the coordinate area, the process proceeds to step S3604 and the target is advanced to the next. Then, the process returns to step S3602 and repeats the above described processing.

On the other hand, in step S3603, if it is determined that the specified location is within the coordinate area of the target layout management data, the target object is set as a return value and the process ends.

In this way, according to the fifth embodiment, the drag & drop operation of objects among the information processing apparatuses can be achieved.

### Sixth Embodiment

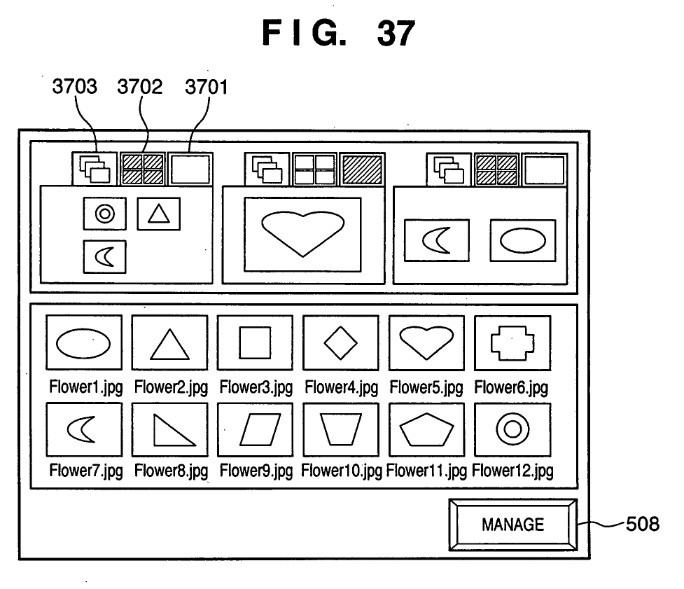

A sixth embodiment according to the present invention will now be described in detail using FIGS. 37 to 41. The sixth embodiment describes, by way of example, a case where the display screen forms in the other apparatuses are controlled.

FIG. 37 illustrates an example operation screen on which display forms in the other apparatuses are designated in the sixth embodiment. Placed on this operation screen are a button 3701 for specifying full-screen display designation, a button 3702 for specifying index display designation, and a button 3703 for specifying overlapping display designation for each apparatus.

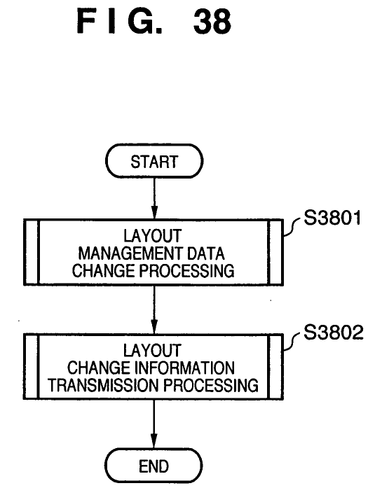

FIG. 38 is a flow chart illustrating display form change processing in the sixth embodiment. First, in step S3801, an object display coordinate area change is made in association with a display form change using layout management data change processing. Then, in step S3802, the layout change information is transmitted to the corresponding apparatus using layout change information transmission processing, and the process ends.

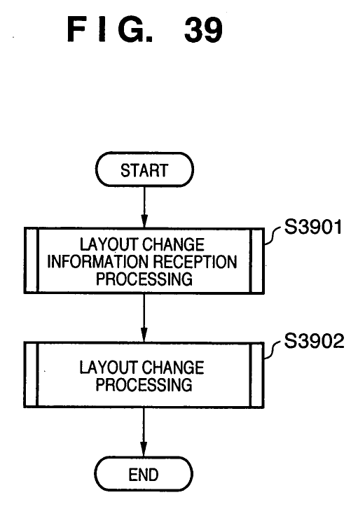

FIG. 39 is a flow chart illustrating display processing of an information processing apparatus in the sixth embodiment. First, in step S3901, the layout change information transmitted from the operation apparatus is received using layout change information reception processing. Then, in step S3902, the display form is changed using layout change processing, and the process ends.

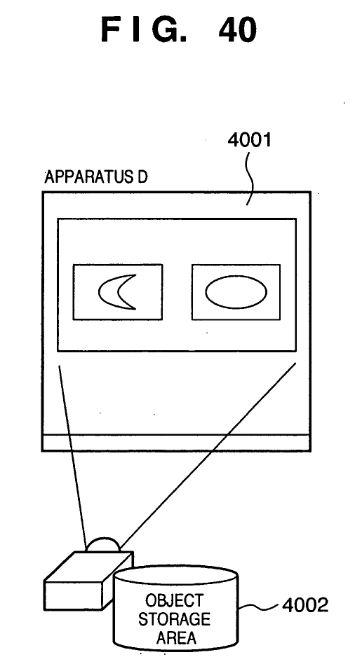

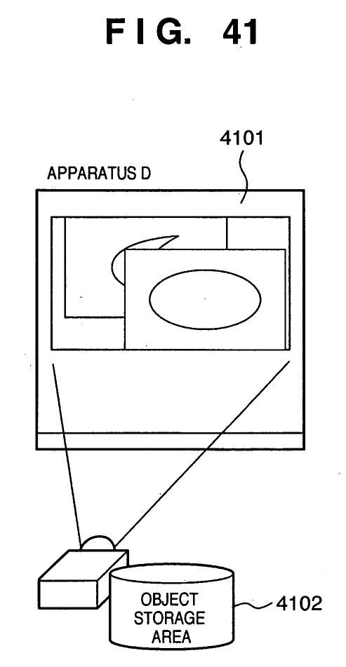

FIG. 40 illustrates an example index display screen of the information processing apparatus in the sixth embodiment. Also, FIG. 41 illustrates an example overlapping display screen of the information processing apparatus in the sixth embodiment. In this example, overlapping display is designated for an object 4002 displayed on the display screen 4001, and the overlapped object 4102 is displayed on the display screen 4101.

In this way, according to the sixth embodiment, the behaviors on the information processing apparatuses can be controlled. Also, the display form, such as overlapping display, full-screen display, or multiple screen display, can be designated.

Note that the present invention may be applied to a system composed of a plurality of devices (e.g. host computers, interface devices, readers, printers, etc.), or may be applied an apparatus composed of a single device (copying machines, facsimile machines, etc.).

Also, it is needless to say that the object of the present invention can be achieved by providing a system or an apparatus with a recording medium recording a software program code for implementing the functions of the above described embodiments and causing the computer (CPU or MPU) of the system or the apparatus to read and execute the program code stored in the recording medium.

In this case, the program code itself read out from the recording medium achieves the functions of the above described embodiments and thus the recording medium storing the program code is deemed to constitute the present invention.

As a recording medium for providing the program code, for example, floppy (registered trademark) disks, hard disks, optical disks, magneto-optical disks, CD-ROM, CD-R, magnetic tapes, non-volatile memory cards, ROM, etc. can be used.

It is also needless to say that the present invention is not limited to implementing the functions of the above described embodiments by executing the program code read out by a computer, but also includes the following case; that is, an OS (operating system) or the like running on a computer may perform part or all of the actual processing based on the instructions of the program code, thereby achieving the functions of the above described embodiments.

Further, it is needless to say that the present invention also includes a case where the program code read out from the recording medium may be written in a memory provided within an expansion board inserted into a computer or an expansion unit connected to a computer, and then, a CPU provided in the expansion board or the expansion unit may perform part or all of the actual processing based on the instructions of the program code, thereby achieving the functions of the above described embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-240201, filed Aug. 22, 2005, which is hereby incorporated by reference herein in its entirety.

What is claimed is:

1. An object operation apparatus capable of operating objects processed in a plurality of information processing apparatuses connected over a network comprising:
display control means for displaying the objects processed in the plurality of information processing apparatuses on a display device in correspondence with the information processing apparatuses, and
operation control means for making operations on the objects corresponding to the information processing apparatuses displayed by the display control means controllable.

2. The apparatus according to claim 1, further comprising conversion means for converting the objects into data formats corresponding to respective display capabilities of the plurality of information processing apparatuses.

3. The apparatus according to claim 1, wherein the display control means divides the display device into a plurality of screens corresponding to the plurality of information processing apparatuses, and displays the objects on the screens.

4. The apparatus according to claim 3, wherein the operations on the objects are at least operations for designating addition of objects to the screens, movement of objects between the screens, and deletion of objects on the screen.

5. The apparatus according to claim 3, wherein the operations on the objects are at least operations for designating object size matching or unmatching, display location matching or unmatching, display or non-display, and deletion.

6. The apparatus according to claim 3, further comprising display form change means for changing the display form of the screens in displaying the objects on the screens.

7. The apparatus according to claim 6, wherein the display form change means changes the display form to any of overlapping display, full-screen display, and multiple screen display.

8. The apparatus according to claim 1, further comprising control means for controlling the operations on the objects from the plurality of information processing apparatuses.

9. The apparatus according to claim 8, further comprising:
operation permission request reception means for receiving an operation permission request for the objects from the plurality of information processing apparatuses,
determination means for determining whether or not to permit the operation of the objects corresponding to the received operation permission request, and
operation permission transmission means for transmitting operation permission for the objects if it is determined that the operation is permitted by the determination means.

10. The apparatus according to claim 1, further comprising transmission/reception means for transmitting/receiving the objects to/from the plurality of information processing apparatuses over the network.

11. An object operation apparatus capable of operating objects processed in a plurality of information processing apparatuses connected over a network comprising:
transmission/reception means for transmitting/receiving objects to/from the plurality of information processing apparatuses over the network, and
operation control means for making operations on any object across the information processing apparatuses controllable.

12. An information processing apparatus comprising:
object reception means for receiving objects from an object operation apparatus capable of operating the objects,
operation permission request means for requesting operation permission for the objects,
operation permission reception means for receiving the operation permission for the objects requested by the operation permission request means, and
operation means for operating the objects for which the operation permission is received by the operation permission reception means.

13. An object operation method capable of operating objects processed in a plurality of information processing apparatuses connected over a network comprising:
a display control step of displaying the objects processed in the plurality of information processing apparatuses in correspondence with the information processing apparatuses on a display device, and
an operation control step of making operations on the objects corresponding to the information processing apparatuses displayed in the display control step controllable.

14. An object operation method capable of operating objects processed in a plurality of information processing apparatuses connected over a network comprising:
a transmission/reception step of transmitting/receiving the objects from/to the plurality of information processing apparatuses over the network, and
an operation control step of making operations on any object across the information processing apparatuses controllable.

15. A program stored on a computer-readable recording medium for causing a computer to execute an object operation method according to claim 13.

16. A program stored on a computer-readable recording medium for causing a computer to execute an object operation method according to claim 14.

17. A computer-readable recording medium recording a program according to claim 15.

18. A computer-readable recording medium recording a program according to claim 16.
